(19) United States
(12) Patent Application Publication
(10) Pub. No.: US 2012/0123753 A1
(43) Pub. Date: May 17, 2012

(54) Method for analyzing longitudinal data, corresponding computer and system

(75) Inventor: Marc Lavielle, Villebon Sur Yvette (FR)

(73) Assignee: INRIA Institut National de Recherche En Informatique Et En Automatique, Le Chesnay (FR)

(21) Appl. No.: 13/298,621

(22) Filed: Nov. 17, 2011

(30) Foreign Application Priority Data
Nov. 17, 2010 (FR) 10 59452

(51) Int. Cl. G06F 17/10

(52) U.S. Cl. 703/2

(57) ABSTRACT

The method according to the invention for analyzing longitudinal data characterizing the evolution of at least a first variable as a function of at least one second variable, comprising steps for determining (22, 24, 26) adjacent variation sub-intervals for at least one of said first and/or second variables and characterizing (28) said data on said sub-intervals wherein the step for determining said sub-intervals comprises:
defining (24) a representative function of a dispersion of said variable in said sub-intervals, the value of which depends on the lower and upper bounds of said sub-intervals, and
determining (26) the lower and upper bounds of said sub-intervals optimizing the value of said function.

### CROSS REFERENCE TO RELATED APPLICATIONS

This application claims priority under 35 USC §119 to French patent application FR 10 59452, filed Nov. 17, 2010, which is incorporated herein by reference in its entirety.

### BACKGROUND OF THE INVENTION

The present invention relates to a method for analyzing longitudinal data characterizing the evolution of at least a first variable as a function of at least one second variable, comprising steps for determining adjacent variation sub-intervals for at least one of said first and/or second variables and characterizing said data on said sub-intervals.

It applies in particular to the automatic production of mathematical model evaluation graphs, such as VPC (Visual Predictive Check) graphs. This type of graph makes it possible to compare data obtained by simulation, using a mathematical model, with real data obtained through observations, when said data assume the form of longitudinal data, i.e. express the evolution of a first variable, hereafter denoted yᵢ, as a function of a second variable, hereafter denoted xᵢ. Such a comparison then makes it possible to choose, form amongst several candidate models, that which has the best data retrieval and/or prediction capacities.

VPC graphs are for example used to assess pharmacokinetic/pharmacodynamic (PK/PD) models, modeling the respective evolutions of the concentration of an active substance in an organism and an effect of that active substance on the organism as a function of time.

A first step for producing a VPC graph consists of generating a large quantity of data simulated using the considered model, i.e. calculating the values taken by the first variable, or studied size, for different values of the second variable, hereafter called the longitudinal coordinate, then showing, on a same graph, the statistical distribution of the observed data and that of the simulated data, for the purpose of comparing those distributions. In fact, a significant difference between these two distributions generally indicates poor suitability of the model for the studied phenomenon.

The observed and simulated data is thus shown on a graph having the longitudinal coordinate on the x axis and the values assumed by the studied size on the y axis, in the form of two sets of points. These two sets generally cannot be directly compared to one another. In fact, the longitudinal coordinates of the simulated data can differ from those of the observed data, and the studied size can assume multiple values for a same longitudinal coordinate.

The comparison of the observed and simulated data is therefore generally done by dividing the variation interval of the longitudinal coordinate into a plurality of adjacent variation sub-intervals, and characterizing the real and/or simulated values assumed by the studied size on each of these sub-intervals, for example by calculating the percentiles of the studied size on each of the sub-intervals. The comparison of the percentiles for the observed and simulated data then makes it possible to measure the suitability of the model for the actual data.

The results of this comparison depend on the choice of the sub-intervals. It is therefore crucial to choose sub-intervals allowing a relevant characterization of the distribution of the data. In particular, these sub-intervals must be wide enough, i.e. contain enough data, so that the actual and/or simulated values assumed by the studied size over said sub-intervals is statistically significant. However, to be able to correctly characterize the evolution of the studied size according to the longitudinal coordinate, it is necessary to determine a sufficient number of sub-intervals, therefore to limit the width thereof.

To choose these sub-intervals, a first known method consists of randomly setting the number K of sub-intervals, and dividing the variation interval of the longitudinal coordinate into K sub-intervals of equal widths. This approach is not satisfactory, because the obtained sub-intervals do not depend on the distribution of the data, distribution which is generally not homogenous, such that some sub-intervals can contain a large quantity of data while other sub-intervals can be empty.

To balance the distribution of the data in the different sub-intervals, a second method consists of determining sub-intervals all having the same total number. This method is more satisfactory than the previous one, as it offers a more balanced distribution of the data in the sub-intervals. However, this method does not make it possible to monitor the dispersion of the data in each of the sub-intervals. A same sub-interval can for example contain data with very different coordinates xᵢ, while data with very close coordinates xᵢ can be distributed in different sub-intervals. Furthermore, while the distribution of a number N of data in K sub-intervals with the same numbers is easy when all of the data has different longitudinal coordinates xᵢ, such a distribution can prove impossible when several data share the same longitudinal coordinate.

The characterization of the real and/or simulated values assumed by the studied size can lead to the same issue. In particular, when the values assumed by the studied size are discrete values, the evaluation of the model does not rely on the comparison of the percentiles of the simulated and observed values, fairly irrelevant, but on the comparison, between the simulated data and the observed data, of the probabilities of obtaining the different possible discrete values. In the case of data for which the set of possible values is not bounded, for example counting data, it is then appropriate to group the possible values together in classes, then to estimate the probabilities of each class. This method leads to defining variation sub-intervals of the studied size as well. The choice of these sub-intervals is also crucial, since the characterization of the real and/or simulated values depends directly on it.

### SUMMARY OF THE INVENTION

The aim of the invention is therefore to propose a method for analyzing longitudinal data not having the drawbacks of the method according to the state of the art, and making it possible to relevantly characterize the evolution of data.

To that end, the invention relates to an analysis method of the aforementioned type, wherein the step for determining said sub-intervals comprises:
defining a representative function of a dispersion of said variable in said sub-intervals, the value of which depends on the lower and upper bounds of said sub-intervals, and
determining the lower and upper bounds of said sub-intervals optimizing the value of said function.

According to other aspects, the method for analyzing longitudinal data includes one or more of the following features:
said function depends on a sum of the norms of order p, with p being greater than or equal to 1, of the variable centered on said sub-intervals,
said function depends on a sum of the variances of said variable on said sub-intervals,
said function further depends on the sum of the variances of the numbers in the different sub-intervals,
the step for determining said sub-intervals comprises determining lower and upper bounds of said sub-intervals minimizing said function,
said function comprises a penalization term, increasing with the number of sub-intervals,
the step for determining said sub-intervals further comprises determining the number of sub-intervals minimizing the value of said function,
said function comprises a term that can be expressed in the form:

$$f = {\sum }_{k = 1}^{K} {\sum }_{i} {{m}_{i} ( {z}_{i} - {a}_{k} )}^{p} + β Pen ( {K}_{x} )$$

in which Kₓ designates the number of sub-intervals, βPen(Kₓ) is a penalization term, the terms zᵢ designate the values assumed by said variable on the sub-interval with index k, and the terms mᵢ designate the number of repetitions of the value zᵢ of said variable in said data.

The invention also relates to a computer program including lines of code which, when executed by a computer, carry out the steps of the analysis method according to the invention, and a system for analyzing longitudinal data, comprising a processing unit that can carry out the method according to the invention, means for inputting longitudinal data into said processing unit, and a man/machine interface comprising display means for displaying said data in graphic form.

### BRIEF DESCRIPTION OF THE DRAWINGS

The invention will be better understood using the following description, provided solely as an example, and done in reference to the appended drawings, in which:

FIG. 1 is a graphic illustration of longitudinal data,

FIG. 2 is a diagram illustrating a longitudinal data analysis system according to one embodiment of the invention,

FIG. 3 is a summary diagram illustrating a longitudinal data analysis method according to one embodiment of the invention, and

FIG. 4 is a graphic illustration of longitudinal data as obtained using the analysis method according to the invention.

### DETAILED DESCRIPTION OF THE PREFERRED EMBODIMENTS

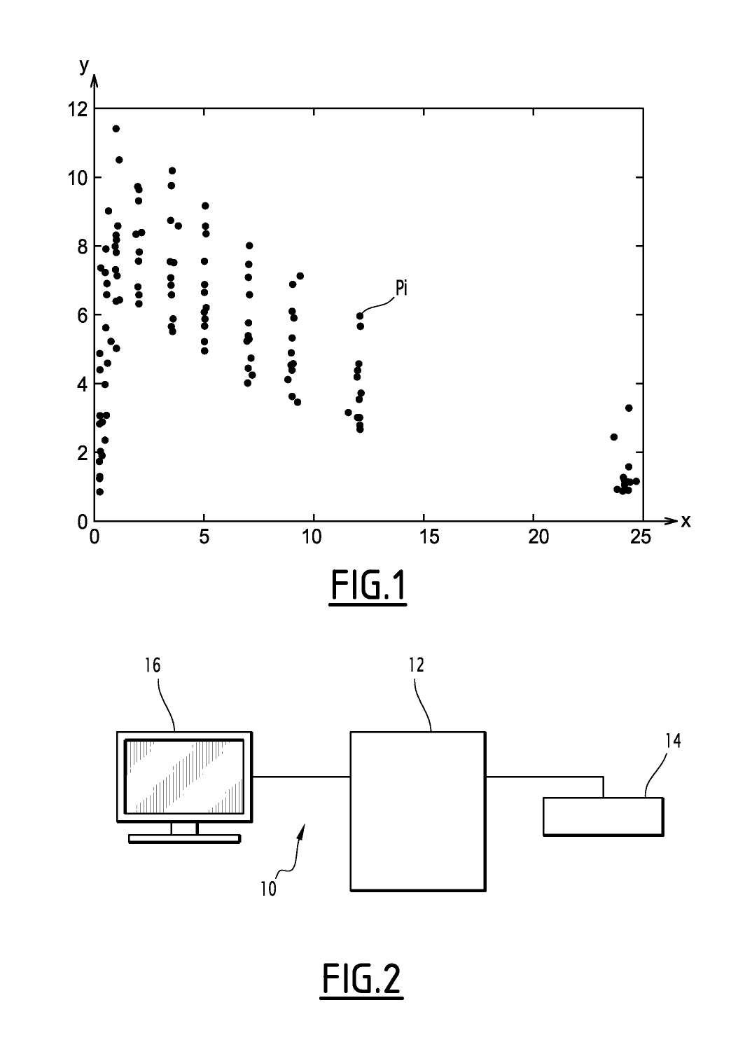

FIG. 1 is an example of graphic illustration of longitudinal data that can be analyzed using the method according to the invention. This data comprises a set of N pairs (xᵢ,yᵢ), i=1, 2, . . . , N, xᵢ and yᵢ representing the values assumed by two random variables x and y, comprised in two intervals respectively denoted I_{X} and I_{Y}, bounded or not bounded. These data represent the evolution of variable y, i.e. of the studied size, as a function of variable x, or longitudinal coordinate. We will subsequently consider that the coordinates x, are ordered in increasing order (i<j [symbol] xⱼ<xⱼ).

These data are shown in FIG. 1 in the form of a graph having variable x on the x axis, and variable y on the y axis, and making it possible to visualize the evolution of the studied size as a function of the longitudinal coordinate, in the form of a set of N points Pᵢ, each of said points being associated with a pair (xᵢ,yᵢ).

This graph is for example a VPC-type graph, and the data shown are for example PK/PD analysis data, obtained by simulation or resulting from clinical observations. The studied size then corresponds to the concentration of an active substance in an organism or the effect of said active substance, while the longitudinal coordinate is generally time.

We will thus consider, in the continuation of the description, that the longitudinal data analyzed are PK/PD analysis data, resulting from observations. However, the method, program and system according to the invention can be applied to any type of longitudinal data.

The values xᵢ assumed by the longitudinal coordinate, i.e. by time, are not necessarily all different from one another. In fact, the experimental or simulated data generally comprise several values of the studied size, measured at the same moments but under different experimental conditions, for example on different patients.

Variable x thus assumes a number L of different values, with L≦N, denoted zⱼ. Z=(z₁, z₂, . . . , z_{L}) thus denotes the different values assumed by variable x, ordered by increasing order, and (m₁, m₂, . . . , m_{L}) the number of respective occurrences of the values (z₁, z₂, . . . , z_{L}) of variable x in the studied data. If all of the values x, of variable x are distinct, L=n and mⱼ=1 for all j=1, 2, . . . , N.

FIG. 2 shows an analysis system 10 according to the invention, able to analyze longitudinal data like those described in reference to FIG. 1.

This analysis system 10 comprises a processing unit 12, means 14 for inputting longitudinal data into the processing unit 12, and a man/machine interface comprising means 16 for displaying said data in graphic form.

The means 14 for inputting longitudinal data into the processing unit 12 can allow the capture or transfer, automatically or by a user, of experimental data, i.e. data resulting from observations, or simulated data, toward the processing unit 12. These input means 14 for example comprise an input peripheral such as a keyboard, and/or a digital media reader and/or a data input port.

The processing unit 12, connected to the input means 14 and the display means 16, can analyze experimental or simulated data coming from the input means 14, and/or simulated data from a model by the processing unit 12, and controlling the display of said data in graphic form by the display means 16.

In particular, the processing unit 12 can optimally and automatically divide the variation interval I_{X} of the longitudinal coordinate x and/or the variation interval I_{Y} of the studied size y into sub-intervals. The processing unit 12 can also characterize the values assumed by the studied size on each of the variation sub-intervals of the longitudinal coordinate x and/or the studied size y, and ordering the display by the display means 16 of a graph synthesizing the data thus analyzed.

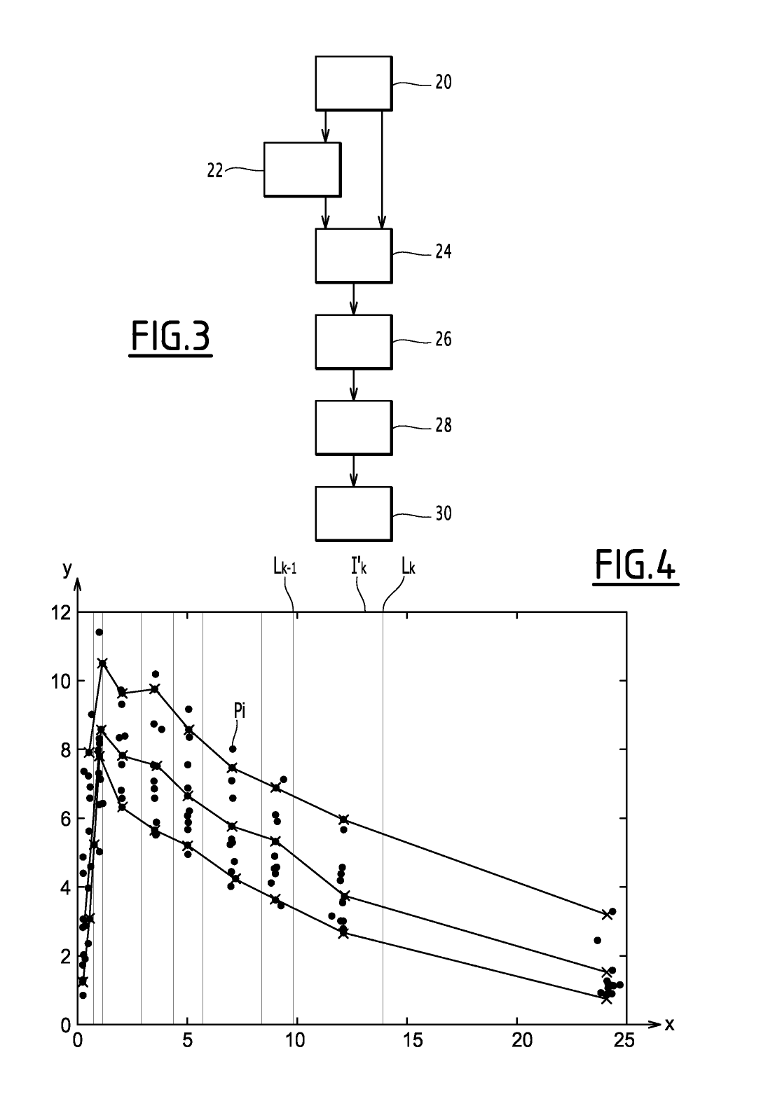

FIG. 3 shows the steps carried out by the analysis system 10 shown in FIG. 2 to analyze longitudinal data as described in reference to FIG. 1, resulting from observations.

In a step 20, these experimental data are captured or transferred to the processing unit 12, via input means 14, to be analyzed by the processing unit 12.

The analysis method according to the invention relies on the determination of adjacent variation sub-intervals of the considered variable, for example variable x, optimizing the dispersion of the data in the different sub-intervals, i.e. the determination or selection of the number Kₓ of sub-intervals and the automatic determination of the lower and upper bounds of the Kₓ sub-intervals of the interval Iₓ optimizing said dispersion.

Each sub-interval Iₖ is defined by the data it contains, i.e. by the set of data whereof the coordinate xᵢ, or equivalently zⱼ, is comprised in said sub-interval Iₖ. The coordinates zⱼ being ordered in increasing order, each sub-interval Iₖ is defined more simply by the minimum and maximum values of the variable z comprised in said sub-interval, respectively denoted z_{τ}_{_{k−1}}₊₁ and z_{τ}_{ₖ}.

The position of the sub-intervals Iₖ is thus determined by determining the “limit values” of variable z defining said intervals, i.e. the subset Z_{T}=(z_{τ}_{₁}, z_{τ}_{₂}, . . . , z_{τ}_{_{Kx−1}}) of the set Z, defined by a vector of Kₓ−1 indexes τ=(τ¹, τ₂, . . . , τ_{Kx-1}) such as 1≦τₖ≦L for all kε[1,Kₓ−1]. Sub-interval Iₖ will thus designate the sub-interval delimited by z_{τ}_{_{k−1}} and Z_{τ}_{ₖ}, by formulating τ₀=0 and τ_{Kx}=L. Each sub-interval Iₖ can thus be defined by Iₖ=┘z_{τ}_{_{k−1}},z_{τ}_{ₖ}┘. Alternatively, each sub-interval Iₖ can be replaced by any interval Iₖ* comprising the data for coordinates xᵢ such as z_{τk-1}<xᵢ≦z_{τ}_{ₖ} and only that data, but the lower and upper bounds of which are not necessarily equal to z_{τ}_{_{k−1}} and z_{τ}_{ₖ}. The two sub-intervals Iₖ and Iₖ* are equivalent, as they contain exactly the same data.

Determining the optimal adjacent variation sub-intervals for variable x thus comprises determining the number Kₓ of sub-intervals and the set Z_{T}, i.e. values (τ₁, τ₂, . . . , τ_{K-1}) of the indices of variable z defining the lower and upper bounds of those sub-intervals.

To that end, the analysis method comprises an optional step 22 for defining the number Kₓ of sub-intervals, during which the number Kₓ of sub-intervals to be determined is set randomly by the processing unit 12 or by the user. The user can, however, choose not to set the number Kₓ of sub-intervals at that stage, in which case that number Kₓ will be determined automatically and optimally in the continuation of the analysis by the processing unit 12.

The determination of adjacent sub-intervals optimizing the dispersion of the data in the different sub-intervals then comprises a step 24 for defining an optimality criterion for choosing said sub-intervals, i.e. a junction Jₓ representative of said dispersion, which depends on the number Kₓ of sub-intervals and their lower and upper bounds, i.e. vector τ.

This function Jₓ can be defined by the user or chosen from amongst several predefined functions, as a function of the studied data. It is expressed generally in the form:

Jₓ(τ,K)=F+βPen(Kₓ)

in which F is a function characterizing the dispersion of the data in the Kₓ different sub-intervals, which depends on the data contained in each of the sub-intervals, therefore the bounds of said intervals, and βPen(Kₓ) is an increasing function of the number Kₓ of sub-intervals, called penalization term, β being a parameter than can be chosen by the user.

Function F can be written in the form

$$F = {\sum }_{k = 1}^{{K}_{x}} {F}_{k} ,$$

, i.e. as a sum of functions Fₖ each measuring the dispersion of the data in the sub-interval of index k.

Function Fₖ is for example defined as a norm of order p, with p greater than or equal to 1, of the variable centered on sub-interval Iₖ. It then measures how the data are distributed within the sub-interval Iₖ, and is expressed in the form:

$${F}_{k} = {\sum }_{i = {τ}_{k - 1} + 1}^{{τ}_{k}} {{m}_{i} ( {z}_{i} - {a}_{k} )}^{p}$$

Here, aₖ minimizes Fₖ. Thus, if p=2, for example, then aₖ is the weighted average z̅ₖ of the values assumed by variable z in sub-interval Iₖ, i.e. the weighted average of the values assumed by variable x in sub-interval Iₖ, defined by:

$${\overline{z}}_{k} = \frac{{\sum }_{i = {τ}_{k - 1} + 1}^{{τ}_{k}} {m}_{i} {z}_{i}}{{\sum }_{i = {τ}_{k - 1} + 1}^{{τ}_{k}} {m}_{i}} .$$

Function F, denoted F⁽¹⁾, is thus equal to the sum of the norms of order p, with p greater than or equal to 1, of the variable centered on the Kₓ sub-intervals:

$${F}^{( 1 )} = {\sum }_{k = 1}^{{K}_{x}} {F}_{k} = {\sum }_{k = 1}^{{K}_{x}} {\sum }_{i = {τ}_{k - 1} + 1}^{{τ}_{k}} {{m}_{i} ( {z}_{i} - {a}_{k} )}^{p}$$

When p is chosen equal to 2, function Fₖ is then proportional to the variance of the values assumed by variable x on sub-interval Iₖ:

$${F}_{k} = {\sum }_{i = {τ}_{k - 1} + 1}^{{τ}_{k}} {{m}_{i} ( {z}_{i} - {a}_{k} )}^{2}$$

Function F⁽¹⁾ is then equal, to within one multiplicative term, to the intra-interval variance of variable x, i.e. to the weighted average of the variances of variable x in each sub-interval.

Function F can also be defined as a function measuring the deviation between the numbers of the different sub-intervals Iₖ, i.e. the number of data for which variable x is comprised in said sub-interval Iₖ, and the average number of ic sub-intervals.

Function F, denoted F⁽²⁾, is then expressed by:

$${F}^{( 2 )} = {\sum }_{k = 1}^{{K}_{x}} f ( {n}_{k} - \frac{N}{{K}_{x}} )$$

where f designates any increasing function,

$${n}_{k} = {\sum }_{i = {τ}_{k - 1} + 1}^{{τ}_{k}} {m}_{i}$$

designates the number of the sub-interval of index k, and

$$\frac{N}{{K}_{x}}$$

represents the average number of the K sub-intervals.

Function F⁽²⁾ is for example proportional to the intra-interval variance of the numbers, and is expressed by:

$${F}^{( 2 )} = {\sum }_{k = 1}^{{K}_{x}} {( {n}_{k} - \frac{N}{{K}_{x}} )}^{2}$$

Function F can be defined as a linear combination of functions F⁽¹⁾ and F⁽²⁾, and then measures not only how the data are distributed within each sub-interval, but also how said data are distributed between the different sub-intervals.

The penalization term βPen(Kₓ) is chosen independently of function F. It is for example proportional to the number ic of sub-intervals:

βPen(Kₓ)=βKₓ

Parameter β can depend on the number N of data. It is for example determined according to different model selection approaches, for example by minimizing an information criterion such as the Aikake information criterion (AIC).

However, if the number Kₓ of sub-intervals was set during step 22, β is chosen equal to zero, so that the penalization term βPen(Kₓ) is also null.

The definition 24 of function Jₓ characterizing the dispersion of the data in the different sub-intervals is followed by a step 26 for determining lower and upper bounds of the sub-intervals optimizing the value of said function J.

During said step 26, the processing unit 12 thus determines the number Kₓ of sub-intervals, if it was not set in step 22, and the vector τ=(Ε₁, τ₂, . . . , τ_{K-1}) minimizing the value of function Jₓ(τ,Kₓ). This step can be carried out using any type of minimization algorithms, for example according to the dynamic programming algorithms described in the document “Using penalized contrasts for the change-point problem” (Lavielle M., Signal Processing, vol. 85, n. 8, pp 1501-1510, 2005).

If the number Kₓ of sub-intervals was set during step 22, the processing unit 12 determines only the vector r=(τ₁, τ₂, . . . , τ_{K}_{ₓ}₋₁) minimizing the value of function J_{X}, i.e. the position of the sub-intervals optimizing the dispersion of the data in these sub-intervals. In particular, if function Jₓ comprises a term expressed in form F⁽¹⁾ defined above, i.e. depends on a sum of the norms of order p of variable x centered on the sub-intervals, the vector τ determined during step 26 is the vector optimizing the distribution of the data within each of the sub-intervals. If the function Jₓ comprises a term expressed in form F⁽²⁾ defined above, the vector τ optimizes the distribution of the data between the different sub-intervals.

If the number Kₓ of sub-intervals was not set during step 22, the processing unit 12 determines, aside from the vector τ=(τ₁, τ₂, τ_{K}_{ₓ}₋₁), the number Kₓ of sub-intervals minimizing the value of function Jₓ, thus establishing a compromise between a larger number of sub-intervals, desirable to evaluate the variation of the studied size, and a large number of data per sub-interval, making it possible to more precisely characterize the data within each sub-interval.

Thus, at the end of step 26, the N data are distributed in Kₓ adjacent sub-intervals, as a function of their coordinate xᵢ. For example, a datum with coordinate xᵢ such as Z_{τ}_{_{k−1}}<xᵢ≦z_{τ}_{ₖ} belongs to sub-interval Iₖ.

Step 26 is followed by a step 28 for characterizing data on each of the sub-intervals, i.e. values assumed by the studied size y on each of said sub-intervals. During this step 28, the processing unit 12 determines, for each sub-interval Iₖ, one or more parameters Yₖ characterizing the values assumed by variable y for the data distributed in that interval Iₖ.

If the values assumed by variable y are continuous, step 28 is for example carried out by determining, in each sub-interval Iₖ, the percentiles of the nₖ values assumed by variable y on that sub-interval, for example the 10th, 50th and 90^{th} percentiles, and the confidence intervals of those percentiles.

Step 28 can also be carried out by grouping together the possible values of variable y in K_{y} classes, and determining, for each of the Kₓ sub-intervals, the likelihood of variable y belonging to each of said K_{y} classes. This type of characterization is particularly suitable when variable y has discrete variables.

The K_{y} classes define K_{y} adjacent variation sub-intervals of variable y. The determination of the number K_{y} of classes and their lower and upper bounds is advantageously done similarly to the determination of the Kₓ variation sub-intervals of variable x. This determination then comprises the definition of a function J_{y} representative of the dispersion of variable y in the K_{y} classes, the value of which depends on the lower and upper bounds of those classes, and potentially comprising a penalization term, and the determination by the processing unit 12 of the lower and upper bounds of said classes optimizing the value of function J_{y}.

This automatic division of the variation interval of variable y into K_{y} classes thus optimizes the distribution of the N data in the K_{y} classes.

Thus, at the end of step 28, each of the K, variation sub-intervals of variable x is associated with one or more sizes Yₖ characterizing the values of variable y on those sub-intervals.

Thus, during step 30, the processing unit 12 controls the display on the display means 16 of the data analyzed in the form of a graph, bearing variable x on the x-axis and variable y on the y-axis, and also representing the Kₓ sub-intervals determined during step 26, as well as the parameters Yₖ characterizing the values of variable y on those sub-intervals.

FIG. 4 thus illustrates a graphic representation of longitudinal data as displayed by the display means during step 30. This graph shows the N data, in the form of N points Pᵢ, identically to the illustration shown in FIG. 1. Also shown are the Kₓ variation sub-intervals Iₖ* of variable x, delimited by Kₓ−1 vertical lines Lₖ, obtained by using a function F⁽¹⁾ as defined above. This graph also shows, in the form of an x, the parameters Yₖ characterizing the values of variable y on each sub-interval, which here are the 10th, 50th and 90^{th} percentiles of variable y, with parameter aₖ defined in function F⁽¹⁾ on the x-axis. These percentiles are connected by segments, so as to visualize their evolution between two consecutive sub-intervals Iₖ.

The analysis method according to the invention thus makes it possible to determine automatically, without requiring expert intervention, optimal variation sub-intervals of the studied variables, and therefore to have a more precise qualitative and quantitative evaluation of the precision of models simulating the real phenomena.

This optimality has several aspects. In particular, the analysis method makes it possible to optimize both the distribution of the data within each sub-interval, and the distribution of the data between the different sub-intervals, the user remaining free to weight the importance of these two criteria in the determination of the sub-intervals. Furthermore, the method according to the invention allows an automatic and optimal determination of the number of sub-intervals, by establishing a compromise between a high number of sub-intervals favoring homogeneity of the data within each sub-interval and making it possible to describe the evolution of the studied size more precisely, and a high number of data in each sub-interval allowing a more precise characterization of the studied size.

It should, however, be understood that the embodiment presented above is not limiting.

In particular, the sub-intervals Iₖ determined during the analysis of the observed data can be used to characterize data resulting from simulations on those same sub-intervals. The results of this analysis are then advantageously shown on the graph of FIG. 4, superimposed on the analysis results of the observed data. Such an illustration thus allows the user to compare the observed data to the simulated data, therefore to evaluate the model used for the simulation, by comparing the parameters Yₖ characterizing the observed data and the simulated data on each sub-interval.

Furthermore, although the method according to the invention was described above in the context of the analysis of VPC data, it can be applied to any type of longitudinal data, characterizing the evolution of at least a first variable as a function of at least one second variable.

What is claimed is:

1. A method for analyzing longitudinal data characterizing the evolution of at least a first variable as a function of at least one second variable, comprising steps for determining adjacent variation sub-intervals for at least one of said first and/or second variables and characterizing said data on said sub-intervals, wherein the step for determining said sub-intervals comprises:
defining a function representative of a dispersion of said variable in said sub-intervals, the value of which depends on the lower and upper bounds of said sub-intervals, and
determining the lower and upper bounds of said sub-intervals optimizing the value of said function.

2. The analysis method according to claim 1, wherein said function depends on a sum of the norms of order p, with p being greater than or equal to 1, of the variable centered on said sub-intervals.

3. The analysis method according to claim 1, wherein said function depends on a sum of the variances of said variable on said sub-intervals.

4. The analysis method according to claim 1, wherein said function also depends on the sum of the variances of the data numbers in the different sub-intervals.

5. The analysis method according to claim 1, wherein the step for determining said sub-intervals comprises determining lower and upper bounds of said sub-intervals minimizing said function.

6. The analysis method according to claim 1, wherein said function comprises a penalization term, increasing with the number of sub-intervals.

7. The analysis method according to claim 6, wherein the step for determining said sub-intervals also comprises determining the number of sub-intervals minimizing the value of said function.

8. The analysis method according to claim 1, wherein said function comprises a term that can be expressed in the form:
$$f = {\sum }_{k = 1}^{K} {\sum }_{i} {{m}_{i} ( {z}_{i} - {a}_{k} )}^{p} + β Pen ( {K}_{x} )$$
in which Kₓ designates the number of sub-intervals, βPen(Kₓ) is a penalization term, the terms zᵢ designate the values assumed by said variable on the sub-interval with index k, and the terms mᵢ designate the number of repetitions of the value zᵢ of said variable in said data.

9. A computer program including lines of code which, when executed by a computer, carry out the steps of the analysis method according to any one of the preceding claims.

10. A system for analyzing longitudinal data, comprising a processing unit that can carry out the method according to any one of claims 1 to 8, means for inputting longitudinal data into said processing unit, and a man/machine interface comprising display means for displaying said data in graphic form.
